(19) United States
(12) Patent Application Publication
(10) Pub. No.: US 2014/0083022 A1
(43) Pub. Date: Mar. 27, 2014

(54) HYBRID TOWER STRUCTURE AND METHOD FOR BUILDING THE SAME

(71) Applicant: EUROSTAL OY, Lahti (FI)

(72) Inventors: Jukka NUMMI, Lahti (FI); Tuomo KUUSI, Mantsala (FI)

(73) Assignee: EUROSTAL OY, Lahti (FI)

(21) Appl. No.: 14/030,098

(22) Filed: Sep. 18, 2013

(30) Foreign Application Priority Data
Sep. 21, 2012 (FI) 20125978

(51) Int. Cl. F03D 11/04; E04H 12/08

(52) U.S. Cl. CPC F03D 11/045; E04H 12/08
USPC 52/40; 52/745.18

(57) ABSTRACT

A hybrid tower structure (1), and a method for building the same, which tower structure includes a lower portion (3) in form of a lattice structure (8, 9), an upper portion (5) with continuous outer surface, and an adapter construction (4) between the lower and upper portions, wherein the tower structure (1) further includes plurality of stay cables (6) connected to the tower structure, and that the lower portion (3) of the tower structure has a hollow cross-section through its length where the load bearing lattice structure (8, 9) extends only on the circumference of the cross section, and the lattice structure is formed from hollow steel profiles.

### FIELD OF THE INVENTION

The present invention relates to a hybrid tower structure and to a method for building such a hybrid tower arrangement. More precisely the invention relates to a hybrid tower structure, where the lower portion of the tower structure is formed as a lattice structure.

### BACKGROUND OF THE INVENTION

Hybrid tower structures and constructions are generally used in wind turbine towers. Examples of these hybrid tower structures for wind turbines comprise concrete-steel hybrids, lattice-conic hybrids and covered lattice hybrids. In concrete-steel hybrids the lower portion of the tower structure is formed from concrete and the upper portion of the tower is generally tubular steel structure. In lattice-conic hybrids the lower portion of the tower is formed as a lattice structure and the upper portion of the tower is generally tubular steel structure. In covered lattice structure the inner portion of the tower is formed as a lattice structure and covered with metal plating, for example.

In these hybrid wind turbine towers, the length of the upper portion of the tower structure is generally based on the length of the blades of the wind turbine so that the end of the blade at its lowest position will be in the area of the upper portion of the tower structure. Thus the height of the lower portion of the hybrid wind tower is generally based on the desired height of the whole wind turbine tower structure. And generally higher wind turbine tower structures are preferred, within reasonable costs of course, since the winds are generally stronger at higher altitudes.

Known lattice-conic tower structures for wind turbines are disclosed in publications WO 2012/024608 and DE 10 2004 020 480, for example.

### SUMMARY OF THE INVENTION

In the present invention a hybrid tower structure comprises a lower portion in form of a lattice structure and an upper portion with continuous outer surface, and an adapter construction between the lower and upper portions, which adapter construction connects the lower and upper portions of the tower structure. Plurality of stay cables are connected to the tower structure to provide support for the tower structure. The lower portion of the tower structure has a hollow cross-section through its length where the load bearing lattice structure extends only on the circumference of the cross section, and the lattice structure is formed from hollow steel profiles.

The use of stay cables in the hybrid tower structure allows adjusting of the specific frequency of the tower structure by adjusting the tension in the stay cables. Preferable at least three stay cables, or pairs of stay cables, are connected to the adapter construction of the tower structure, and each of the stay cables are fixed in a separate fixing base from their exterior or outer ends, each of the fixing bases being separate from each other and from the base of the lower portion of the tower structure. The stay cables and their separate fixing bases also allow use of a smaller and lighter base for the lower portion of the tower structure than in the prior art constructions and solutions.

The stay cables are advantageously connected detachably to the adapter construction of the tower structure, through bolted connections for example. Thus there is no need for welding or other complicated fixing operations during building and/or erecting the tower structure. Further, the connection points of the stay cables in the adapter construction are advantageously substantially evenly spaced around the circumference of the adapter construction, and located substantially in the same horizontal plane.

The lattice structure of the lower portion of the tower structure is in the present invention formed so that the lattice structure extends only on the circumference of the cross section of the lower portion. Thus the center area within the lower portion of the tower structure is free to be used for other purposes. The free center area provides room for different types of equipment, provides free and safer passage from the top of the tower structure or at least from top of the lower portion, and prevents vandalism, for example.

In the present invention the lattice structure of the lower portion of the tower structure is formed from hollow steel profiles. The hollow steel profiles provide better load bearing capacity compared to elongated flat steel bars, steel L-profiles or combined steel L-profiles used in prior art lattice structures, and thus allows the free inner space inside the lower portion of the tower structure.

Preferable the hollow steel profiles forming the lattice structure are made from corrosion-resistant steel. Use of the corrosion-resistant steel as a material of the lattice profiles also removes the need for coating the surfaces of lattice structure with suitable protective material, especially for the surfaces inside the hollow steel profiles.

The upper portion of the tower structure according to the invention comprises continuous outer surface and is advantageously made of steel, and is in a form of a hollow truncated cone. The upper portion can be single piece or it can be manufactured from separate sections or parts connected to each other to form single tubular entity. This type of upper portion provides similar type of appearance than the known tubular type tower structures have, since the upper portion of the tower structure is the portion of the tower seen from further away. This type of upper portion also allows smaller outer dimensions of the upper portion and is suitable for the present power generation solutions.

The cross section of the lower portion of the tower structure according to the invention has advantageously three or more corners. This type of angular cross-section allows use of corner beams extending upwards along the length of the lower portion of the tower structure, which corner beams provide support and fixing points for the lattice structure extending between adjacent corner beams.

In the present invention the lattice structure of the lower portion of the tower structure is advantageously formed from pre-fabricated lattice sections. This way the actual building or erecting phase of the tower construction can be speeded up.

Further, the pre-fabricated lattice sections are advantageously connected to other lattice sections through bolted joints, or with other suitable detachable connections, such as with lock nuts, with rivets, etc. This way the connecting of the prefabricated lattice sections can be carried out quickly and easily and without need for hot work, such as welding. The jointed connections also make the dismantling of the tower structure relatively fast and easy.

Advantageously the tower structure of the present invention is a tower structure for wind turbine. Other suitable applications for a tower structure according to the present invention include different types of industrial smart structures, power transmission line supports, telecommunication towers and masts, antenna constructions, and crane frames, for example.

In the method for building a hybrid tower structure according to the present invention first a base for the tower structure is formed, on which base formed and fixed a lattice structure forming a lower portion of the tower structure. The lattice structure is formed from prefabricated level lattice modules by connecting the prefabricated level lattice modules in the building site to adjacent lattice modules to form a closed angular lattice section. Once the lattice section is complete, the first lattice section is lifted and fixed on the base. Then another lattice section is formed from prefabricated lattice modules and lifted and fixed on top of the first lattice section located on the base. This process is continued until sufficient amount of lattice structures are piled and fixed on top of each other to reach the predetermined height of the lower portion of the tower structure. Then an adapter construction and a tubular upper portion are lifted and or built on top of the lower portion of the tower structure for completing the tower structure.

In the method according to present invention advantageously plurality of pairs of connected prefabricated lattice modules are formed by connecting two adjacent lattice modules to each other in an angle when the lattice modules are lengthwise in horizontal orientation, lifting the pairs of connected lattice modules lengthwise to vertical orientation, and connecting the adjacent pairs of connected lattice modules to form the closed angular lattice section. The closed angular lattice section is advantageously formed from three such pairs of connected lattice modules.

Advantageously in the methods plurality of stay cables are connected from one end detachably to the adapter construction and from other end to separate fixing bases, and the tension of the stay cables is adjusted.

The connecting of the lattice modules in the method is advantageously done through bolted joints, or through with other suitable detachable connections.

The method according to the present invention provides a fast, and thus a cost-efficient, method for building the tower structure.

Exemplifying embodiment of the invention and its advantages are explained in greater detail below in the sense of example and with reference to accompanying drawings, where:

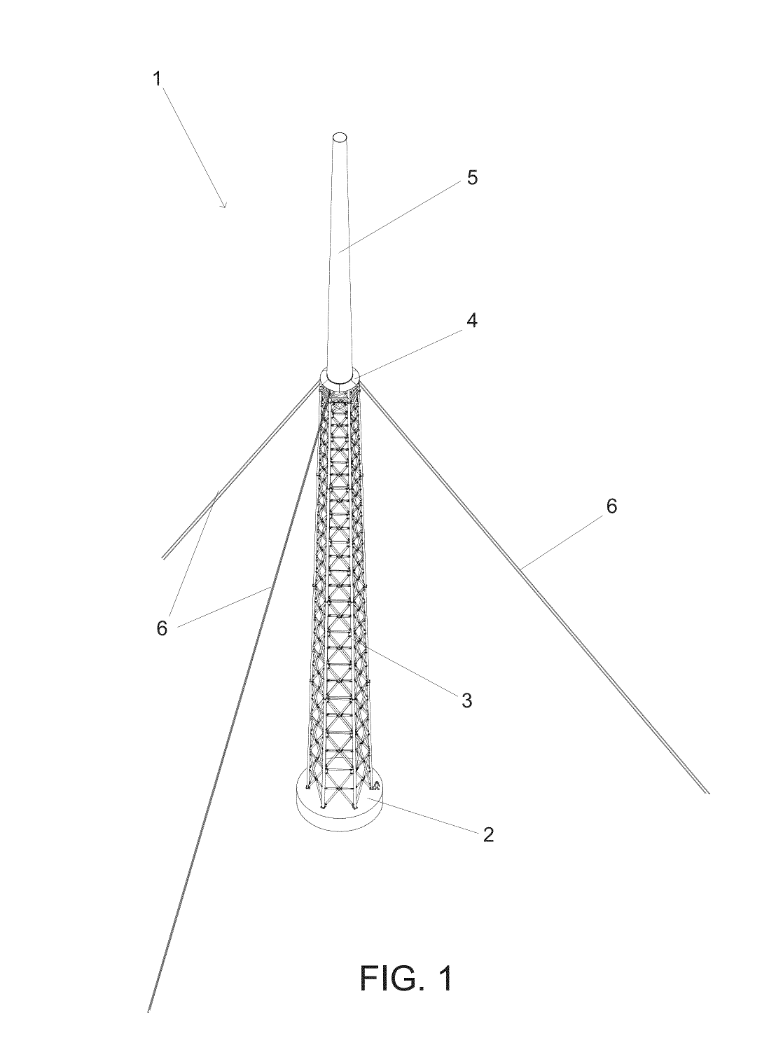

FIG. 1 shows schematically a tower structure according to an embodiment of the invention,

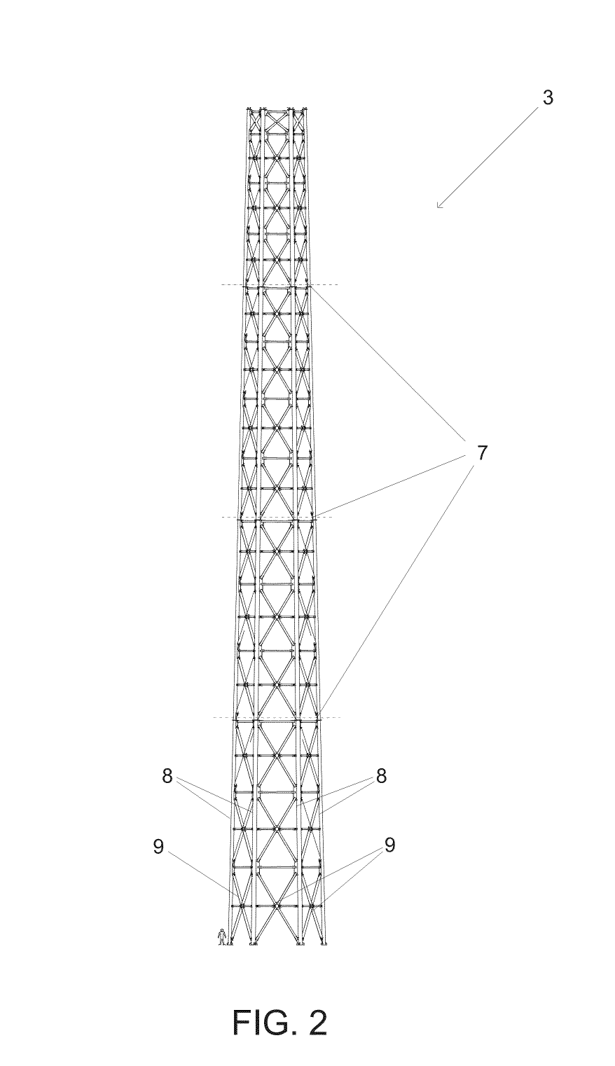

FIG. 2 shows side view of the lattice structure forming the lower portion of the tower structure of FIG. 1,

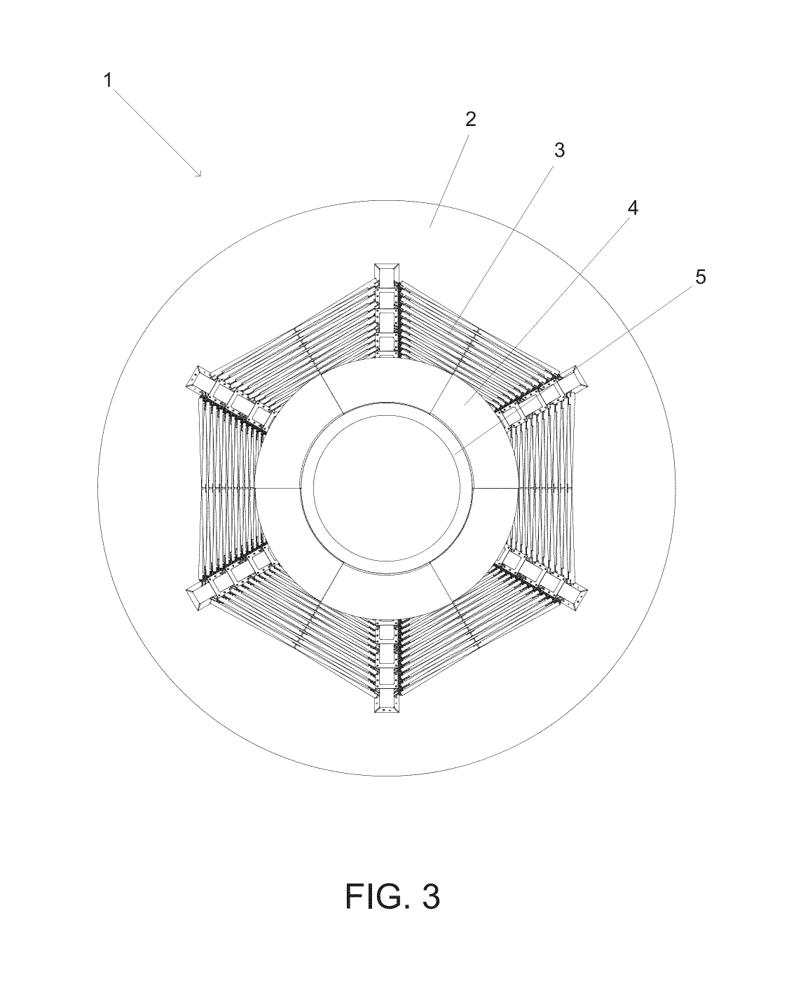

FIG. 3 show top view of the tower structure of FIG. 1, and

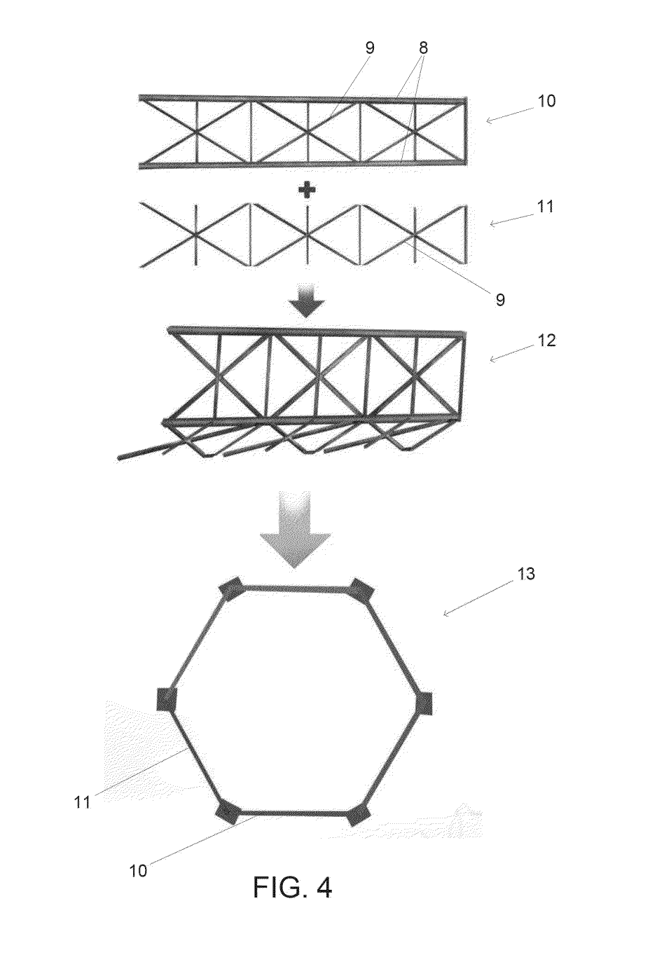

FIG. 4 shows schematically part of steps in a method according to an embodiment of the invention.

15

### BRIEF DESCRIPTION OF THE DRAWINGS

The tower structure 1 according to an embodiment of the invention shown in FIG. 1 comprises a tower base 2, a lower portion 3, an adapter construction 4, an upper portion 5, and stay cables 6. The tower structure 1 of the embodiment of FIG. 1 is for a wind turbine.

### DETAILED DESCRIPTION OF THE INVENTION

The tower base 2 is usually formed from reinforced concrete prior to the actual building or erecting of the tower structure to predefined location. The tower base 2 carries the weight of the tower structure and thus needs to be designed accordingly.

The lower portion 3 of the tower structure 1 is formed as a lattice structure. The lower portion 3 is built or erected on the tower base 2 and fixed on it.

The adapter construction 4 is fixed on top of the lower portion 3 of the tower structure 1. The adapter construction 4 covers the upper end of the lower portion 3 and provides fixing base for the upper portion 5 having smaller diameter at its lower end than what the diameter of the upper end of the lower portion is.

The stay cables 6 are connected from their upper ends to the adapter structure 1, and from their lower, exterior ends to own fixing basis (not shown), which fixing bases are separate from the tower base 2 and located at suitable distances from the tower base. In the embodiment of FIG. 1 there are three pairs of stay cables 3, which pairs are connected to the adapter construction 4 at equal distances around the circumference of the adapter construction. The stay cables 6 are also connected to the adapter construction 4 through bolted joints, or with other suitable detachable means. The stay cables 6 are equipped with suitable means for adjusting the tension of the wires, which can be used to adjust the stiffness of the tower structure 1 that makes it possible to obtain desired specific frequencies for the tower structure.

The upper portion 5 of the tower structure 1 is fixed on top of the adapter construction 4. The upper portion 5 is in this embodiment a single tubular steel part.

On top of the upper portion 5 of the tower structure 1 is in this embodiment of the invention attached a wind turbine (not shown) together with required gear stages and a generator, for example.

FIG. 2 shows more closely the lower portion 3 of the tower structure 1 of figure 1, which lower portion is divided to four lattice sections by connecting points or planes 7.

Each lattice section of the lower portion 3 of the tower structure comprises six corner beams 8, which corner beams extend substantially vertically along the length of the lattice section at the corners of the lattice sections. The lattice sections are connected by connecting the corner beams 8 of subsequent lattice sections to form the lower portion of the tower structure.

The adjacent corner beams 8 are connected by lattice structures 9, which consist of a plurality interconnected hollow corrosion-resistant steel profiles. The corner beams 8, which are also hollow corrosion-resistant steel profiles, are provided with flanges through which flanges the lattice structures 9 can be connected with bolted joints.

FIG. 3 provides a top view of the tower structure 1 of FIG. 1 without stay cables 6, showing the tower base 2, the lower portion 3, the adapter construction 4, and the upper portion 5.

FIG. 4 shows schematically the steps of a method according to the invention for forming a lattice section in building and erecting a tower structure according to the invention.

In this embodiment of a method according to the invention, two different kinds of prefabricated level lattice modules 10, 11 are produced and transported to the building site of the tower structure. The first prefabricated module 10 comprises two corner beams 8 connected with a lattice structure 9, and the another prefabricated module 11 consist of a lattice structure 9.

The two prefabricated lattice modules 10, 11 are connected when both of the modules 10, 11 are lengthwise in horizontal orientation by connecting the lattice module 11 formed only by the lattice structure 9 to one of the corner beams 8 of the first lattice module 10 in an angle, as can be seen from FIG. 4. Three of these types of pairs 12 of lattice modules 10, 11 are made for forming one lattice section in this embodiment.

Then the pairs 12 of the lattice modules 10, 11 are lifted lengthwise in vertical orientation and connected to each other to form a closed angular lattice section 13 of a lower portion of the tower structure.

These lattice sections 13 are then piled and fixed one on top another on a tower base to form the lower portion of the tower structure, on top of the lower portion is lifted and fixed an adapter construction, brace wires are connected to the adapter construction, and an upper portion is lifted and fixed on top of the adapter construction in order to build or erect a tower structure in accordance with the invention.

The specific exemplifying embodiments of the invention shown in figures and discussed above should not be construed as limiting. A person skilled in the art can amend and modify the exemplary tower structure and method described above many evident ways within scope of the attached claims. Thus the invention is not limited merely to the embodiments described above.

1. A hybrid tower structure (1) comprising a lower portion (3) in form of a lattice structure (8, 9), an upper portion (5) with continuous outer surface, an adapter construction (4) between the lower and upper portions, the lower portion (3) of the tower structure has a hollow cross-section through its length where the load bearing lattice structure (8, 9) extends only on the circumference of the cross section, and the lattice structure is formed from hollow steel profiles, wherein the tower structure (1) further comprises plurality of stay cables (6) connected to the tower structure for obtaining specific frequencies for the tower structure.

2. A tower structure (1) according to claim 1, wherein the hollow steel profiles of the lattice structure (8, 9) are made from corrosion-resistant steel.

3. A tower structure (1) according to claim 1, wherein the stay cables (6) are detachably attached to the tower structure (1), and preferable to the adapter construction (4) of the tower structure.

4. A tower structure (1) according to claim 1, wherein the upper portion (5) of the tower structure (1) is made of steel and is in a form of a hollow truncated cone.

5. A tower structure (1) according to claim 1, wherein the cross section of the lower portion (3) of the tower structure (1) comprises 3 or more corners, and in each of the corners extend substantially vertical corner beam.

6. A tower structure (1) according to claim 1, wherein the tower structure (1) comprises at least three stay cables (6), each of which have their own fixing base at their exterior ends, which bases are separate from the base (2) of the lower portion (3) of the tower structure, and the tension of each of the stay cable is adjustable.

7. A tower structure (1) according to claim 1, wherein the lower portion (3) of the tower structure (1) is formed from pre-fabricated sections (10, 11).

8. A tower structure (1) according to claim 1, wherein the tower structure (1) is a tower structure for wind turbine.

9. A method for building a hybrid tower structure (1), in which method a base (2) for the tower structure is formed, on the base is formed and fixed a lattice structure (8, 9) forming a lower portion (3) of the tower structure, on top of the lower portion is lifted and fixed an adapter construction (4), on top of the adapter construction is lifted and fixed an upper portion (5) with continuous outer surface, the lower portion (3) is formed of prefabricated level lattice modules (10, 11) by connecting the prefabricated level lattice modules in the tower building site to adjacent lattice modules to form a closed angular lattice section (13), which section is then lifted on the base or on top of the previous lattice section and fixed there, and the formation and lifting of the lattice sections are carried out until the predetermined height of the lower portion of the tower structure (1) is reached, wherein plurality of stay cables (6) are connected to the tower structure (1) for obtaining specific frequencies for the tower structure.

10. A method according to claim 9, wherein plurality of pairs (12) of connected lattice modules (10, 11) are formed by connecting two adjacent lattice modules to each other in an angle when the lattice modules are lengthwise in horizontal orientation, lifting the pairs of connected lattice modules lengthwise to vertical orientation, and connecting the adjacent pairs of connected lattice modules to form the closed angular lattice section (13).

11. A method according to claim 10, wherein the closed angular lattice section (13) is formed from three pairs (12) of connected lattice modules (10, 11).

12. A method according to claim 9, wherein plurality of stay cables (6) are connected from one end detachably to the tower structure (1), preferable to the adapter construction (4), and from other end to separate fixing bases, and the tension of the stay cables is adjusted.

13. A method according to claim 9, wherein the prefabricated lattice modules (10, 11) are connected to adjacent lattice modules through bolted joints or with other suitable detachable connections.

14. A tower structure (1) according to claim 2, wherein the stay cables (6) are detachably attached to the tower structure (1), and preferable to the adapter construction (4) of the tower structure.

15. A tower structure (1) according to claim 2, wherein the upper portion (5) of the tower structure (1) is made of steel and is in a form of a hollow truncated cone.

16. A tower structure (1) according to claim 3, wherein the upper portion (5) of the tower structure (1) is made of steel and is in a form of a hollow truncated cone.

17. A tower structure (1) according to claim 2, wherein the cross section of the lower portion (3) of the tower structure (1) comprises 3 or more corners, and in each of the corners extend substantially vertical corner beam.

18. A tower structure (1) according to claim 3, wherein the cross section of the lower portion (3) of the tower structure (1) comprises 3 or more corners, and in each of the corners extend substantially vertical corner beam.

19. A tower structure (1) according to claim 4, wherein the cross section of the lower portion (3) of the tower structure (1) comprises 3 or more corners, and in each of the corners extend substantially vertical corner beam.

20. A tower structure (1) according to claim 2, wherein the tower structure (1) comprises at least three stay cables (6), each of which have their own fixing base at their exterior ends, which bases are separate from the base (2) of the lower portion (3) of the tower structure, and the tension of each of the stay cable is adjustable.
